(19) United States
(12) Patent Application Publication
(10) Pub. No.: US 2025/0218022 A1
(43) Pub. Date: Jul. 3, 2025

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventors: John Kenji David CLARK, Tokyo (JP); Shigeru NAKAMURA, Tokyo (JP)

(73) Assignee: NEC Corporation, Minato-ku, Tokyo (JP)

(21) Appl. No.: 18/851,215

(22) PCT Filed: Jun. 5, 2023
(86) PCT No.: PCT/JP2023/020799

§ 371 Date: Sep. 26, 2024

(30) Foreign Application Priority Data
Jun. 15, 2022 (JP) 2022-096468

(51) Int. Cl. G06T 7/64

(52) U.S. Cl. CPC G06T 7/64; G06T 2207/10101

(57) ABSTRACT

An information processing method comprising: acquiring three-dimensional data on a target; calculating curvature information indicating a curvature of a surface of the target, on the basis of the three-dimensional data; calculating curvilinear coordinates of a plurality of first positions on the surface of the target, on the basis of the curvature information; calculating curvilinear coordinates of a plurality of second positions on the surface of the target, which are different from the plurality of first positions, on the basis of the curvature information and the curvilinear coordinates of the plurality of first positions; and generating a curved surface image indicating the surface of the target, on the basis of the curvilinear coordinates of the plurality of first positions and the curvilinear coordinates of the plurality of second positions.

This application is a National Stage Entry of PCT/JP2023/020799 filed on Jun. 5, 2023, which claims priority from Japanese Patent Application 2022-096468 filed on Jun. 15, 2022, the contents of all of which are incorporated herein by reference, in their entirety.

### TECHNICAL FIELD

This disclosure relates to technical fields of an information processing apparatus, an information processing method, and a recording medium.

### BACKGROUND ART

Patent Literature 1 describes a technique/technology of: acquiring choroid information from a fundus image of a subject eye; and determining whether an ocular fundus has any abnormality by comparing the choroid information with a standard database of choroid. Patent Literature 2 describes a technique/technology of: acquiring optical coherence tomography (OCT) data in three dimensions for an intraoral feature, wherein at least one dimension is pseudo-randomly or randomly sampled; reconstructing an image volume of the intraoral feature by using compressive sensing, wherein data density of the reconstructed image volume is greater than data density of the acquired OCT data in the at least one dimension or by a corresponding transformation; and rendering the image volume reconstructed for display. Patent Literature 3 describes a technique/technology of acquiring a tomographic image by combined light of reference light and return light from a subject eye obtained by irradiating the subject eye with measurement light, the technique/technology including: a first step of measuring a distance between the subject eye and an objective lens; a second step of acquiring the tomographic image of the subject eye; a third step of setting a region for calculating a curvature in the tomographic image; and a fourth step of calculating a curvature of the set region by using the measured distance. Patent Literature 4 describes a contactless fingerprint matching device that increases the accuracy of matching by acquiring matching data considering the attitude of a finger, wherein the device includes: a camera unit and a laser radiation unit for generating data on a finger face including a fingerprint; a measurement unit for measuring a three-dimensional position of the finger face according to the finger face data; a calculation unit for computing a terminal axis direction according to the measured three-dimensional position; a setting unit for setting a curvilinear coordinate system defining a curved surface formed by a first group of lines of intersection of the finger face and a longitudinal section group substantially parallel to the terminal axis direction and by a second group of lines of intersection of the finger face and a cross section group substantially perpendicular to the longitudinal section group; a fingerprint image data acquisition unit for acquiring fingerprint image data represented in a predetermined plane coordinate system; and a matching data acquisition unit for producing, from the fingerprint image data, intermediate data represented in the curvilinear coordinate system and computing, from the intermediate data, matching data represented in a coordinate system of a virtual plane into which the curved surface corresponding to the curvilinear coordinate system is virtually developed.

### CITATION LIST

### Patent Literature

Patent Literature 1: JP2020-058647A
Patent Literature 2: JP2019-518936A
Patent Literature 3: JP2012-147977A
Patent Literature 4: JP2006-172258A

### SUMMARY

### Technical Problem

It is an example object of this disclosure to provide an information processing apparatus, an information processing method, and a recording medium that aim to improve the techniques/technologies disclosed in Citation List.

### Solution to Problem

An information processing apparatus according to an example aspect of this disclosure includes: an acquisition unit that acquires three-dimensional data on a target; a curvature calculation unit that calculates curvature information indicating a curvature of a surface of the target, on the basis of the three-dimensional data; a first position calculation unit that calculates curvilinear coordinates of a plurality of first positions on the surface of the target, on the basis of the curvature information; and a reconfiguration unit including: a second position calculation unit that calculates curvilinear coordinates of a plurality of second positions on the surface of the target, which are different from the plurality of first positions, on the basis of the curvature information and the curvilinear coordinates of the plurality of first positions; and a generation unit that generates a curved surface image indicating the surface of the target, on the basis of the curvilinear coordinates of the plurality of first positions and the curvilinear coordinates of the plurality of second positions.

An information processing method according to an example aspect of this disclosure includes: acquiring three-dimensional data on a target; calculating curvature information indicating a curvature of a surface of the target, on the basis of the three-dimensional data; calculating curvilinear coordinates of a plurality of first positions on the surface of the target, on the basis of the curvature information; calculating curvilinear coordinates of a plurality of second positions on the surface of the target, which are different from the plurality of first positions, on the basis of the curvature information and the curvilinear coordinates of the plurality of first positions; and generating a curved surface image indicating the surface of the target, on the basis of the curvilinear coordinates of the plurality of first positions and the curvilinear coordinates of the plurality of second positions.

A recording medium according to an example aspect of this disclosure is a recording medium on which a computer program that allows a computer to execute an information processing method is recorded, the information processing method including: acquiring three-dimensional data on a target; calculating curvature information indicating a curvature of a surface of the target, on the basis of the three-dimensional data; calculating curvilinear coordinates of a plurality of first positions on the surface of the target, on the basis of the curvature information; calculating curvilinear coordinates of a plurality of second positions on the surface of the target, which are different from the plurality of first positions, on the basis of the curvature information and the curvilinear coordinates of the plurality of first positions; and generating a curved surface image indicating the surface of the target, on the basis of the curvilinear coordinates of the plurality of first positions and the curvilinear coordinates of the plurality of second positions.

### BRIEF DESCRIPTION OF DRAWINGS

FIG. 1 is a block diagram illustrating a configuration of an information processing apparatus in a first example embodiment.

FIG. 2 is a block diagram illustrating a configuration of an information processing apparatus in a second example embodiment.

FIG. 3 is a conceptual diagram illustrating a relation between three-dimensional spatial coordinates and curvilinear coordinates.

FIG. 4A illustrates a curved surface image.

FIG. 4B illustrates a two-dimensional image in which three-dimensional data are projected on a plane surface.

FIG. 5 is a flowchart illustrating a flow of an information processing operation performed by the information processing apparatus in the second example embodiment.

FIG. 6A is a conceptual diagram illustrating an information processing operation performed by an information processing apparatus in a third example embodiment.

FIG. 6B is a conceptual diagram illustrating an information processing operation performed by an information processing apparatus in a third example embodiment.

FIG. 6C is a conceptual diagram illustrating an information processing operation performed by an information processing apparatus in a third example embodiment.

FIG. 6D is a conceptual diagram illustrating an information processing operation performed by an information processing apparatus in a third example embodiment.

FIG. 6E is a conceptual diagram illustrating an information processing operation performed by an information processing apparatus in a third example embodiment.

FIG. 7 is a flowchart illustrating a flow of an information processing operation performed by an information processing apparatus in a fourth example embodiment.

FIG. 8 is a block diagram illustrating a configuration of an information processing apparatus according to a fifth example embodiment.

FIG. 9 is a flowchart illustrating a flow of an information processing operation performed by the information processing apparatus in the fifth example embodiment.

FIG. 10 is a block diagram illustrating a configuration of an information processing apparatus in a sixth example embodiment.

FIG. 11 is a flowchart illustrating a flow of an information processing operation performed by the information processing apparatus in the sixth example embodiment.

FIG. 12 is a block diagram illustrating a configuration of an information processing apparatus in a seventh example embodiment.

FIG. 13 is a flowchart illustrating a flow of an information processing operation performed by the information processing apparatus in the seventh example embodiment.

### DESCRIPTION OF EXAMPLE EMBODIMENTS

Hereinafter, an information processing apparatus, an information processing method, and a recording medium according to example embodiments will be described with reference to the drawings.

### 1: First Example Embodiment

An information processing apparatus, an information processing method, and a recording medium according to a first example embodiment will be described. The following describes the information processing apparatus, the information processing method, and the recording medium according to the first example embodiment, by using an information processing apparatus 1 to which the information processing apparatus, the information processing method, and the recording medium according to the first example embodiment are applied.

### [1-1: Configuration of Information Processing Apparatus 1]

With reference to FIG. 1, a configuration of the information processing apparatus 1 in the first example embodiment will be described. FIG. 1 is a block diagram illustrating the configuration of the information processing apparatus 1 in the first example embodiment.

As illustrated in FIG. 1, the information processing apparatus 1 includes an acquisition unit 11, a curvature calculation unit 12, a first position calculation unit 13, and a reconfiguration unit 14. The acquisition unit 11 acquires three-dimensional data about a target. The curvature calculation unit 12 calculates curvature information indicating a curvature of a surface of the target, on the basis of the three-dimensional data. The first position calculation unit 13 calculates curvilinear coordinates of a plurality of first positions of the target, on the basis of the curvature information. The reconfiguration unit 14 includes a second position calculation unit 141 and a generation unit 142. The second position calculation unit 141 calculates curvilinear coordinates of a plurality of second positions on the surface of the target, which are different from the plurality of first positions, on the basis of the curvature information and the curvilinear coordinates of the plurality of first positions. The generation unit 142 generates a curved surface image indicating the surface of the target, on the basis of the curvilinear coordinates of the plurality of first positions and the curvilinear coordinates of the plurality of second positions.

[1-2: Technical Effect of Information processing Apparatus 1]

The information processing apparatus 1 in the first example embodiment is capable of generating the curved surface image indicating the surface of the target, on the basis of the curvilinear coordinates of the plurality of first positions and the curvilinear coordinates of the plurality of second positions. That is, the information processing apparatus 1 is capable of generating a desired curved surface image, i.e., an accurate curved surface image of the target, on the basis of the three-dimensional data about the plurality of first positions that are a smaller number of positions than the number of positions for which it is desired to acquire three-dimensional information required for generation of the curved surface image.

### 2: Second Example Embodiment

An information processing apparatus, an information processing method, and a recording medium according to a second example embodiment will be described. The following describes the information processing apparatus, the information processing method, and the recording medium according to the second example embodiment, by using an information processing apparatus 2 to which the information processing apparatus, the information processing method, and the recording medium according to the second example embodiment are applied.

### [2-1: Configuration of Information Processing Apparatus 2]

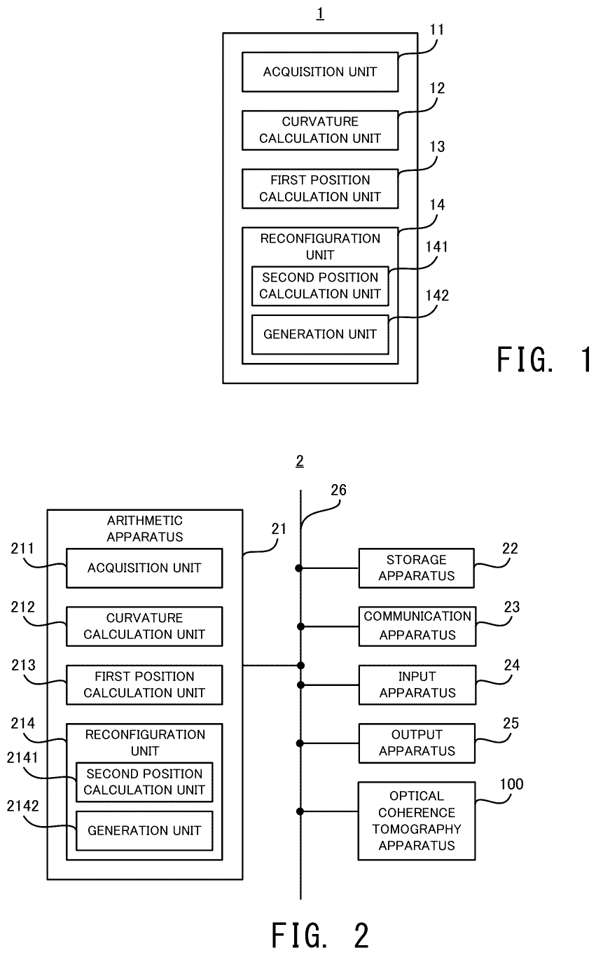

With reference to FIG. 2, a configuration of the information processing apparatus 2 in the second example embodiment will be described. FIG. 2 is a block diagram illustrating the configuration of the information processing apparatus 2 in the second example embodiment.

As illustrated in FIG. 2, the information processing apparatus 2 includes an arithmetic apparatus 21 and a storage apparatus 22. Furthermore, the information processing apparatus 2 may include an optical coherence tomography apparatus 100, a communication apparatus 23, an input apparatus 24, and an output apparatus 25. The information processing apparatus 2, however, may not include at least one of the optical coherence tomography apparatus 100, the communication apparatus 23, the input apparatus 24 and the output apparatus 25. When the information processing apparatus 2 does not include the optical coherence tomography apparatus 100, the information processing apparatus 2 may transmit and receive information with the optical coherence tomography apparatus 100, through the communication apparatus 23. The arithmetic apparatus 21, the storage apparatus 22, the optical coherence tomography apparatus 100, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical functional block for performing an operation to be performed by the information processing apparatus 2 is realized or implemented in the arithmetic apparatus 21. That is, the arithmetic apparatus 21 is allowed to function as a controller for realizing or implementing the logical functional block for performing an operation (in other words, processing) to be performed by the information processing apparatus 2.

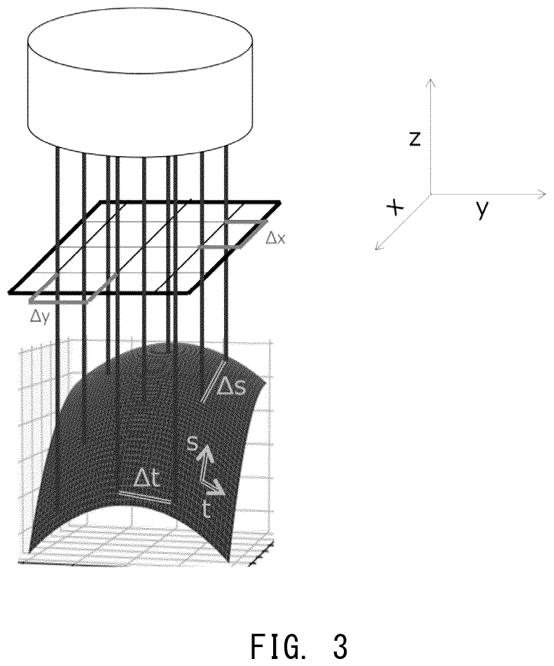

FIG. 2 illustrates an example of the logical functional block realized or implemented in the arithmetic apparatus 21 to perform an information processing operation. As illustrated in FIG. 2, an acquisition unit 211 that is a specific example of the “acquiring unit” described in Supplementary Note later, a curvature calculation unit 212 that is a specific example of the “curvature calculation unit” described in Supplementary Note later, a first position calculation unit 213 that is a specific example of the “first position calculation unit” described in Supplementary Note later, and a reconfiguration unit 214 that is a specific example of the “reconfiguration unit” described in Supplementary Note later, are realized or implemented in the arithmetic apparatus 21. Each operation of the acquisition unit 211, the curvature calculation unit 212, the first position calculation unit 213, and the reconfiguration unit 214 will be described later with reference to FIG. 3 to FIG. 5.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The communication apparatus 23 is configured to communicate with an apparatus external to the information processing apparatus 2 through a not-illustrated communication network. The communication apparatus 23 may be a communication interface based on a standard such as Ethernet (registered trademark), Wi-Fi (registered trademark), Bluetooth (registered trademark), and USB (Universal Serial Bus). When the communication apparatus 23 is a communication interface based on the USB standard, the communication apparatus 23 may be configured to communicate with the arithmetic apparatus 21 including a FPGA, and a mechanism including a computer that controls the entire information processing apparatus 2, for example.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse trackball, a touch panel, a pointing device such as a pen tablet, a button, and the like) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. Examples of the display apparatus include a liquid crystal display, an OLED (Organic Light Emitting Diode) display, and the like. For example, the output apparatus 25 may output information as audio/sound. That is, the output apparatus 25 may include an audio apparatus (a so-called speaker) that is configured to output audio/sound. For example, the output apparatus may output information onto a paper surface. That is, the output apparatus 25 may include a print apparatus (a so-called printer) that is configured to print desired information on the paper surface. The input apparatus 24 and the output apparatus 25 may be integrally formed as a touch panel.

The hardware configuration illustrated in FIG. 2 is an example. An apparatus other than the apparatuses illustrated in FIG. 2 may be added, and a part of the apparatuses may not be provided. In addition, a part of the apparatuses may be replaced by another apparatus having a same/similar function. In addition, a part of the functions in the second example embodiment may be provided by another apparatus through a network. The functions in the second example embodiment may be distributed to and realized in a plurality of apparatuses. As described above, the hardware configuration illustrated in FIG. 2 may be changeable as appropriate.

In the second example embodiment, the three-dimensional data may be three-dimensional luminance data generated by irradiating the target with a light beam while performing two-dimensional scanning and by performing optical coherence tomography.

### [2-2: Optical Coherence Tomography Apparatus 100]

The optical coherence tomography apparatus 100 irradiates the target with a light beam while performing two-dimensional scanning, performs optical coherence tomography, and generates the three-dimensional luminance data on the target.

The optical coherence tomography is a technique/technology of identifying a position in an optical axis direction of a light scattering point where object light is scattered in the target, i.e., in a depth direction of the target, by using interference between the object light and reference light, and acquiring structural data spatially resolved in the depth direction of an inside of the target. The optical coherence tomography technique/technology includes Time Domain (TD-OCT) and Fourier Domain (FD-OCT). In the FD-OCT, an interference light spectrum in a wide wavelength band is measured in the interference of the object light and the reference light, and is Fourier-transformed to acquire the structural data in the depth direction. A method of acquiring the interference light spectrum includes Spectral Domain (SD-OCT) using a spectrometer and Swept Source (SS-OCT) using a light source for sweeping a wavelength. Hereinafter, described is an example in which the optical coherence tomography apparatus 100 performs the optical coherence tomography in the SS-OCT, but the three-dimensional luminance data on the target are not limited to those obtained by the SS-OCT system, but may be obtained by the TD-OCT and the SD-OCT.

The optical coherence tomography apparatus 100 may scan an irradiation position of object light in an in-plane direction perpendicular to a depth direction of the target, thereby to acquire tomography structural data spatially resolved in the in-plane direction and spatially resolved in the depth direction, i.e., three-dimensional tomography structural data on a measurement target. The optical coherence tomography apparatus 100 may include a light source, a scanner unit, and a signal processing unit.

The light source may emit light while sweeping a wavelength. The optical coherence tomography apparatus 100 may branch the light emitted from the light source, to the object light and reference light. The scanner unit irradiates the target with the object light and scatters it. The object light scattered from the target interferes with the reference light reflected by the reference light mirror, and two rays of interference light are generated. That is, an intensity ratio of the two rays of interference light is determined by a phase difference between the object light and the reference light. The scanner unit outputs an electric signal corresponding to a difference in intensity between the two rays of interference light, to the signal processing unit.

The signal processing unit digitizes the electric signal outputted by the scanner unit. The signal processing unit Fourier-transforms the generated interference light spectrum data, and acquires data indicating intensity of backscattered light (object light) at different depth positions in the depth direction (also referred to as a “Z direction”). An operation of acquiring the data indicating the intensity of the backscattered light (object light) in the depth direction (Z direction) of the irradiation position of the object light in the target, is referred to as “A-scan”. The signal processing unit generates a waveform indicating object light backscatter intensity at Nz points, as a A-scan waveform.

The scanner unit scans the irradiation position of the object beam on the target. The scanner unit moves the irradiation position of the object light in a scanning line direction (also referred to as a “fast axis direction of the scanning” and an “X direction”).

The signal processing unit repeats the A-scan operation for each irradiation position of the object light, and may connect the A-scan waveforms at the respective irradiation positions of the object light. As a result, the signal processing unit acquires a map of the intensity of two-dimensional backscattered light (object light) in the scanning line direction (X direction) and in the depth direction (Z direction), as a tomography image. Hereinafter, an operation of repeating the A-scan operation while moving in the scanning line direction (the fast axis direction of the scanning, the X direction) and connecting measurement results, is referred to as “B-scan”. In a case where there are Nx irradiation positions of the object light for each B scan, the tomography image by the B scan is two-dimensional luminance data indicating the object light backscatter intensity at Nz×Nx points.

The scanner unit moves the irradiation position of the object light not only in the scanning line direction (X direction), but also in a direction perpendicular to the scanning line (also referred to as a “slow axis direction of the scanning” and a “Y direction”). The signal processing unit repeats the B-scan operation and may connect B-scan measurement results. In this way, the signal processing unit acquires three-dimensional tomography structural data. Hereinafter, an operation of repeating the B scan operation while moving in the direction perpendicular to the scanning line (Y direction) and connecting measurement results, is referred to as “C scan”. In a case where the number of the B-scans performed for each C-scan is Ny, the tomography structural data obtained by the C-scan are three-dimensional luminance data indicating the object light backscatter intensity at Nz×Nx×Ny points.

The signal processing unit transmits digitized data to the arithmetic apparatus 21. The operation performed by the signal processing unit may be performed by the arithmetic apparatus 21.

### [2-3: Information Processing Operation Performed by Information Processing Apparatus 2]

With reference to FIG. 3 to FIG. 5, a flow of an information processing operation performed by the information processing apparatus 2 in the second example embodiment will be described. FIG. 3 is a conceptual diagram illustrating a relation between three-dimensional spatial coordinates and curvilinear coordinates.

As illustrated in FIG. 3, even if measurement positions are at constant intervals in spatial coordinates (X,Y), the measurement positions are at irregular intervals in corresponding curvilinear coordinates (s, t). This causes distortion in the extracted image.

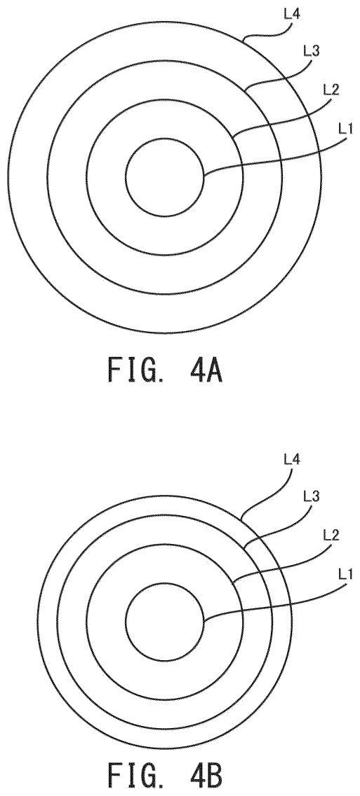

FIG. 4A illustrates the curved surface image of the surface of the target, and FIG. 4B illustrates a conceptual diagram of a two-dimensional image when a curved surface of the surface of the target is orthogonally projected on a tangent plane of a highest elevation point of the curved surface. That is, as illustrated in FIG. 4A, in the surface of the target (curved surface), an interval between L1 and L2, an interval between L2 and L3, and an interval between L3 and L4 are equal to each other. In this case, when the surface of the target (curved surface) is projected on a plane surface, as illustrated in FIG. 4B, each of the interval between L1 and L2, the interval between L2 and L3, and the interval between L3 and L4 becomes smaller as it is further away from a central part.

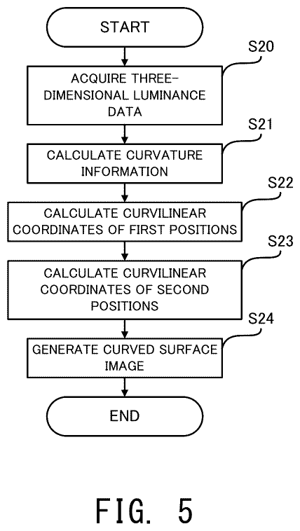

FIG. 5 is a flowchart illustrating a flow of the information processing operation performed by the information processing apparatus 2 in the second example embodiment. As illustrated in FIG. 5, the acquisition unit 211 acquires the three-dimensional luminance data generated by irradiating the target with the light beam while performing the two-dimensional scanning and by performing the optical coherence tomography (step S20).

The curvature calculation unit 212 calculates the curvature information indicating the curvature of the surface of the target, on the basis of the three-dimensional luminance data (step S21). The curvature calculation unit 212 may extract the curved surface corresponding to the surface of the target, on the basis of the three-dimensional luminance data. When the target is a finger, the curved surface may be at least one of a curved surface shape corresponding to epidermis and a curved surface corresponding to dermis. The curvature calculation unit 212 may detect a main curvature of the extracted curved surface. The main curvature may be a curvature of a rough curved surface in which fine irregularities are ignored, such as a skin pattern, for example.

The first position calculation unit 213 calculates the curvilinear coordinates of the plurality of first positions on the surface of the target, on the basis of the curvature information (step S22). Each of the plurality of first positions may correspond to respective one of the irradiation positions of a plurality of rays of object light by the optical coherence tomography apparatus 100. The first position may be a position of the curved surface acquired on the basis of the A-scan operation performed on the irradiation position of the object light by the optical coherence tomography apparatus 100. The first position calculation unit 213 may calculate the curvilinear coordinates of each first position, on the basis of the spatial coordinates of each first position and the curvature information.

A second position calculation unit 2141 calculates the curvilinear coordinates of the plurality of second positions on the surface of the target, which are different from the plurality of first positions, on the basis of the curvature information and the curvilinear coordinates of the plurality of first positions (step S23).

A generation unit 2142 generates the curved surface image indicating the surface of the target, on the basis of the curvilinear coordinates of the plurality of first positions and the curvilinear coordinates of the plurality of second positions (step S24). The information processing operation performed by the information processing apparatus 2 in the second example embodiment may be an operation of creating a map that is a plane surface, on the basis of a globe that is a sphere.

### [2-4: Technical Effect of Information Processing Apparatus 2]

An optical coherence tomography time is determined in accordance with an A-scan capability of the optical coherence tomography apparatus 100 and the number of positions to be desirably irradiated. For example, when the optical coherence tomography apparatus 100 capable of performing the A-scan at 400,000 points per second is used and one image is obtained by scanning approximately 87000 positions of 295 points in the X direction by 295 points in the Y direction, the optical coherence tomography time is approximately 0.22 seconds. The target may wobble during 0.22 seconds, and if it wobbles, it influences and reduces the accuracy of the image. Therefore, it is desirable that the optical coherence tomography time can be shortened. It is, however, relatively hard to reduce the time required for the A-scan.

The information processing apparatus 2 in the second example embodiment is capable of generating the curved surface image indicating the surface of the target, on the basis of the curvilinear coordinates of the plurality of first positions at which the A scan is actually performed, and the curvilinear coordinates of the plurality of second positions at which the A scan is not actually performed. That is, the information processing apparatus 2 is capable of generating a desired curved surface image, i.e., an accurate curved surface of the target, on the basis of the three-dimensional luminance data obtained by the A-scan for a smaller number of positions than the number of positions for which it is desired to acquire the three-dimensional information required for the generation of the curved surface image. That is, the information processing apparatus 2 is capable of acquiring the curved surface image with higher resolution than that of the three-dimensional data. Therefore, the information processing apparatus 2 is capable of acquiring an accurate curved surface image and shortening the optical coherence tomography time, thereby preventing a reduction in the accuracy of the image caused by the wobble of the target. The operation by the information processing apparatus 2 may be realized by a general optical coherence tomography apparatus, and a special scanning technique/technology and a control technique/technology are not required.

### 3: Third Example Embodiment

An information processing apparatus, an information processing method, and a recording medium according to a third example embodiment will be described. The following describes the information processing apparatus, the information processing method, and the recording medium according to the third example embodiment, by using an information processing apparatus 3 to which the information processing apparatus, the information processing method, and the recording medium according to the third example embodiment are applied.

The information processing apparatus 3 in the third example embodiment is different from the information processing apparatus 2 in the second example embodiment, in a second position calculation operation performed by the second position calculation unit 2141. Other features of the information processing apparatus 3 may be the same as those of the information processing apparatus 2. For this reason, a part that is different from each of the example embodiments described above will be described in detail below, and a description of the other overlapping parts will be omitted as appropriate.

### [3-1: Second Position Calculation Operation by Information Processing Apparatus 3]

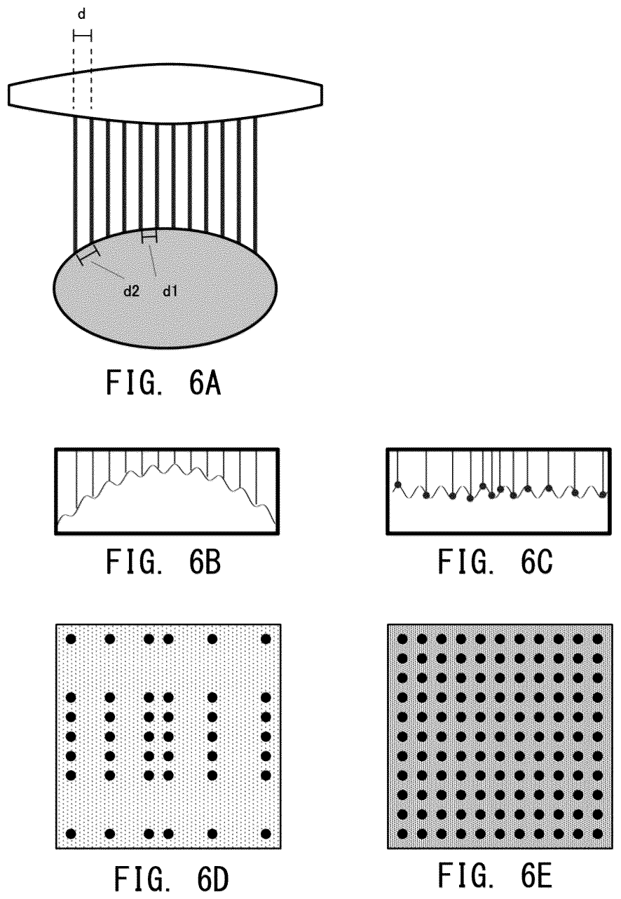

As illustrated in FIGS. 6A to 6E, in the third example embodiment, the target of the optical coherence tomography may be, for example, a finger.

As illustrated in FIG. 6A, even when an interval d in an XY plane is constant, each interval is uneven on the curved surface, as illustrated by an interval d1 and an interval d2.

FIG. 6B is a conceptual diagram illustrating raw data obtained in the optical coherence tomography. The relatively fine irregularities in FIG. 6B may indicate a skin pattern. The curved surface illustrated in FIG. 6B may correspond to at least one of a shape of the epidermis and a shape of the dermis.

FIG. 6C is a conceptual diagram when the spatial coordinates in the conceptual diagram illustrated in FIG. 6B are transformed into the curvilinear coordinates. In a curvilinear coordinate system, it can be seen that the interval in a lateral direction increases as it is further away from the central part. This corresponds to the illustration that the interval d2 is greater than the interval d1 in FIG. 6A. When comparing FIG. 6B and FIG. 6C, it can be seen that the interval in the lateral direction increases in an area having a larger curvature of the surface of the target.

FIG. 6D illustrates the curved surface image including the first positions obtained by measurement. As illustrated in FIG. 6D, on the curved surface corresponding to the surface of the target, the plurality of first positions are non-uniform and/or irregular. More specifically, on the curved surface, there are a smaller number of the plurality of first positions as it is further away from the central part.

In the third example embodiment, the second position calculation unit 2141 calculates the curvilinear coordinates of a larger number of second positions in an area having a larger curvature of the surface of the target, on the basis of the curvature information and the curvilinear coordinates of the plurality of first positions. FIG. 6E illustrates the curved surface image generated by the generation unit 2142 on the basis of the curvilinear coordinates of the plurality of first positions and the curvilinear coordinates of the plurality of second positions calculated by the second position calculation unit 2141. As illustrated in FIG. 6E, the information processing apparatus 3 in the third example embodiment is capable of obtaining a high-resolution image including a plurality of uniform and regular positions including the plurality of first positions and the plurality of second positions.

### [3-2: Technical Effect of Information Processing Apparatus 3]

In many cases, a control of evenly spacing scan positions is easier than a control of unevenly spacing the scan positions. On the other hand, when the surface of the target surface is a curved surface and evenly spaced positions are scanned, the scanned positions exist at unequal intervals on the curved surface image. The information processing apparatus 3 in the third example embodiment is capable of generating a high-resolution curved surface image including a plurality of uniform and regular positions including the plurality of first positions and the plurality of second positions.

### 4: Fourth Example Embodiment

An information processing apparatus, an information processing method, and a recording medium according to a fourth example embodiment will be described. The following describes the information processing apparatus, the information processing method, and the recording medium according to the fourth example embodiment, by using an information processing apparatus 4 to which the information processing apparatus, the information processing method, and the recording medium according to the fourth example embodiment are applied.

The information processing apparatus 4 in the fourth example embodiment is different from the information processing apparatus 2 in the second example embodiment and the information processing apparatus 3 in the third example embodiment, in a reconfiguration operation by the reconfiguration unit 214. Other features of the information processing apparatus 4 may be the same as those of at least one of the information processing apparatus 2 and the information processing apparatus 3. For this reason, a part that is different from each of the example embodiments described above will be described in detail below, and a description of the other overlapping parts will be omitted as appropriate.

### [4-1: Compressive Sensing]

When a natural object is imaged, several assumptions may be made regarding pixel luminance. The natural object often varies smoothly, and the luminance thus changes mainly smoothly. It is also likely that some type of pattern appears in a change in the luminance due to a structure of the target. The luminance abruptly changes at an edge of the target, but the change in the luminance along the edge may be assumed to be continuous, or similar assumption is possible.

For example, when the target is a fingerprint, its pattern ridge has periodicity. When cosine transform is assigned to an image with this periodicity, it is possible to obtain an image with sparse properties with fewer frequency components. This sparse image may be referred to as a sparse representation. The sparse representation includes few non-zero components and many zero components.

Compressive sensing utilizes the property that the sparse representation includes few non-zero components and many zero components. Specifically, it utilizes the property that a sparse representation equivalent to a sparse representation extracted from an image that uses its all pixels (referred to as an “original image”) can be extracted from an image that does not use its all pixels or an image with irregular pixel spacing (referred to as an “irregular sampling curved surface image”). The original image may be a high-resolution curved surface image.

Supposed that, to a sparse representation obtained by transforming (referred to as “Transformation 1”) and extracting the original image, an inverse transformation of Transformation 1 (referred to as “Transformation 2”) is applied. In this case, it is possible to reconstruct the original image. The sparse representation may also be transformed (Transformation 3) to reconstruct the image that does not use its all pixels. The sparse representation can also be extracted by optimizing the sparse representation so as to accurately reconstruct the image that does not use its all pixels when Transformation 3 is applied. Then, when Transformation 2 is applied to the extracted sparse representation, it is also possible to reconstruct an image equivalent to the original image. That is, by applying the compressive sensing, it is possible to reconstruct the image equivalent to the original image, on the basis of the image that does not use its all pixels. For example, Transformation 1 may be Uniform cosine transform, and in this case, Transformation 2 may be Inverse Uniform cosine transform. Furthermore, for example, Transformation 3 may be Inverse Non-Uniform cosine transform.

### [4-2: Information Processing Operation by Information Processing Apparatus 4]

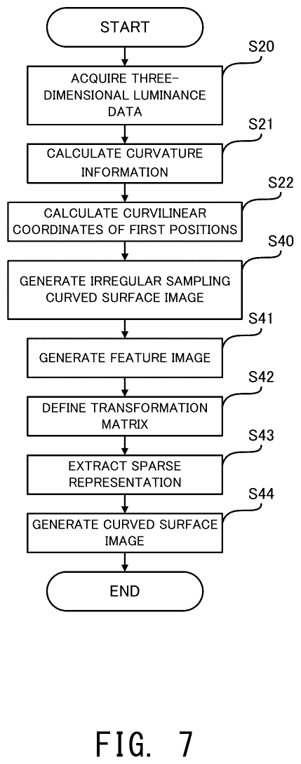

As illustrated in FIG. 7, the acquisition unit 211 acquires the three-dimensional luminance data generated by irradiating the target with the light beam while performing the two-dimensional scanning and by performing the optical coherence tomography (step S20). The curvature calculation unit 212 calculates the curvature information indicating the curvature of the surface of the target, on the basis of the three-dimensional luminance data (step S21). The first position calculation unit 213 calculates the curvilinear coordinates of the plurality of first positions on the surface of the target, on the basis of the curvature information (step S22). As described above, each of the plurality of first positions may correspond to respective one of the irradiation positions of a plurality of rays of object light by the optical coherence tomography apparatus 100. The first position may be a position of the curved surface acquired on the basis of the A-scan operation performed on the irradiation position of the object light by the optical coherence tomography apparatus 100. Hereinafter, the first position is referred to as a measurement position, as appropriate. The first position calculation unit 213 may calculate the curvilinear coordinates of each measurement position, on the basis of the spatial coordinates of each measurement position and the curvature information.

The reconfiguration unit 214 generates the curved surface image on the basis of the curvilinear coordinates of each first position (step S40). When the spatial coordinates of the measurement position are projected on a plane surface, the measurement position corresponds to the irradiation position of the object light and exists uniformly. On the other hand, on the curved surface corresponding to the surface of the target, the curvilinear coordinates of the measuring position are non-uniform and/or irregular. Therefore, the curvilinear coordinates of the measurement position are also referred to as irregular sampling coordinates. Furthermore, the curved surface image generated from the measured positions is also referred to as an irregular sampling surface image. That is, the reconfiguration unit 214 may generate the irregular sampling surface image on the basis of each of the irregular sampling coordinates.

The reconfiguration unit 214 generates a feature image of the irregular sampling curved surface image (step S41). Features that constitute the feature image may be numerical values obtained from the three-dimensional luminance data, and the numerical values may be values indicating the luminance, values indicating depth, values indicating density, or the like.

The reconfiguration unit 214 defines a transformation matrix Aₛₐₘₚₗₑ for transforming a sparse representation x of the curved surface image into an irregular sampling curved surface image yₛₐₘₚₗₑ, on the basis of Equation 1 below (step S42).

$${y}_{sample} = {A}_{sample} x \qquad [ Equation 1 ]$$

The irregular sampling surface image yₛₐₘₚₗₑ may be the curved surface image generated in the step S40. The reconfiguration unit 214 may define, for example, Inverse Non-uniform cosine transform as the transformation matrix Aₛₐₘₚₗₑ. The transformation matrix Aₛₐₘₚₗₑ may be transformation corresponding to Transformation 3 described above.

The reconfiguration unit 214 extracts the sparse representation x that optimizes a loss function for obtaining sparsity (step S43). As the loss function, for example, LASSO regression (least absolute shrinkage and selection operator) may be used. The reconfiguration unit 214 may extract the sparse representation x that minimizes the following Equation 2, for example.

$${min}_{x} ( \frac{1}{2} {‖ {A}_{sample} x - {y}_{sample} ‖}_{2}^{2} + λ {‖ x ‖}_{1} ) \qquad [ Equation 2 ]$$

The reconfiguration unit 214 transforms the sparse representation x into a high-resolution curved surface image in the curvilinear coordinates (step S44). The reconfiguration unit 214 may transform the sparse representation into the high-resolution curved surface image in the curvilinear coordinates by applying transformation corresponding to Transformation 2 described above. The reconfiguration unit 214 may perform inverse transformation by using Inverse Uniform cosine transform, for example.

That is, the reconfiguration unit 214 generates the curved surface image by applying the compressive sensing (steps S40 to S44). The reconfiguration unit 214 may apply the compressive sensing to the irregular sampling curved surface image, thereby to reconstruct the high-resolution curved surface image including a plurality of uniform positions in the curvilinear coordinates. The reconfiguration unit 214 may apply the compressive sensing to the irregular sampling curved surface image, thereby to reconstruct the curved surface image equivalent to the original high-resolution image.

### [4-3: Technical Effect of Information Processing Apparatus 4]

The information processing apparatus 4 in the fourth example embodiment generates the curved surface image by applying the compressive sensing to the calculated curvature information and curvilinear coordinate. That is, the information processing apparatus 4 applies the compressed sensing to a two-dimensional image. Therefore, the operation performed by the information processing apparatus 4 includes a smaller amount of calculation and a lighter processing load than those when the compressive sensing is applied to the three-dimensional luminance data including information about Nz×Nx×Ny points. The information processing apparatus 4 is capable of generating an accurate curved surface image, with a relatively small amount of calculation and a relatively light processing load.

### 5: Fifth Example Embodiment

An information processing apparatus, an information processing method, and a recording medium according to a fifth example embodiment will be described. The following describes the information processing apparatus, the information processing method, and the recording medium according to the fifth example embodiment, by using an information processing apparatus to which the information processing apparatus, the information processing method, and the recording medium according to the fifth example embodiment are applied.

### [5-1: Configuration of Information Processing Apparatus 5]

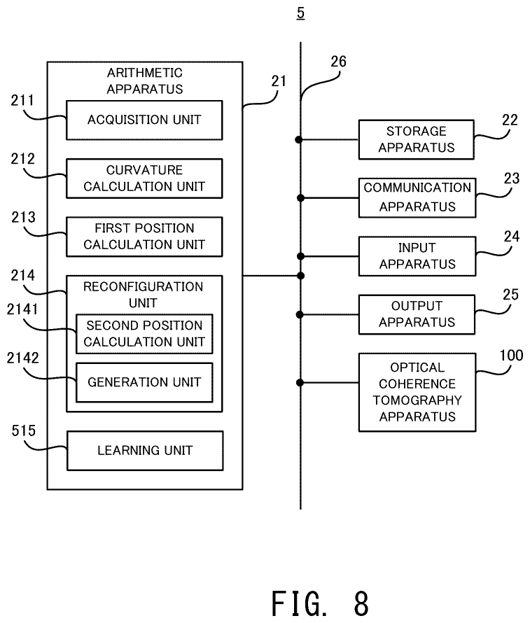

With reference to FIG. 8, a configuration of the information processing apparatus 5 in the fifth example embodiment will be described. FIG. 8 is a block diagram illustrating the configuration of the information processing apparatus 5 in the fifth example embodiment.

As illustrated in FIG. 8, the information processing apparatus 5 in the fifth example embodiment includes the arithmetic apparatus 21 and the storage apparatus 22, as in at least one of the information processing apparatus 2 om the second example embodiment to the information processing apparatus 4 in the fourth example embodiment. Furthermore, the information processing apparatus 5 may include the optical coherence tomography apparatus 100, the communication apparatus 23, the input apparatus 24, and the output apparatus 25, as in at least one of the information processing apparatus 2 in the second example embodiment to the information processing apparatus 4 in the fourth example embodiment. The information processing apparatus 5, however, may not include at least one of the optical coherence tomography apparatus 100, the communication apparatus 23, the input apparatus 24, and the output apparatus 25. The information processing apparatus 5 in the fifth example embodiment is different from at least one of the information processing apparatus 2 in the second example embodiment to the information processing apparatus 4 in the fourth example embodiment, in that the arithmetic apparatus 21 includes a learning unit 515. Other features of the information processing apparatus may be the same as those of at least one of the information processing apparatus 2 in the second example embodiment to the information processing apparatus 4 in the fourth example embodiment. For this reason, a part that is different from each of the example embodiments described above will be described in detail below, and a description of the other overlapping parts will be omitted as appropriate.

### [5-2: Learning Operation by Information Processing Apparatus 5]

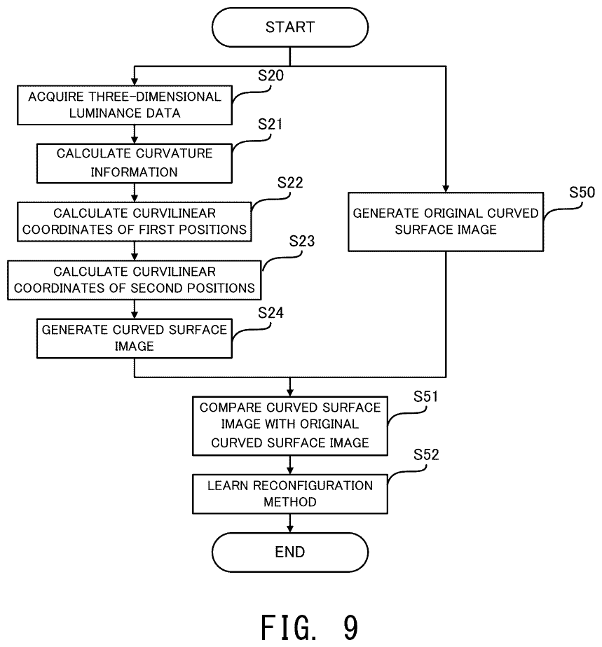

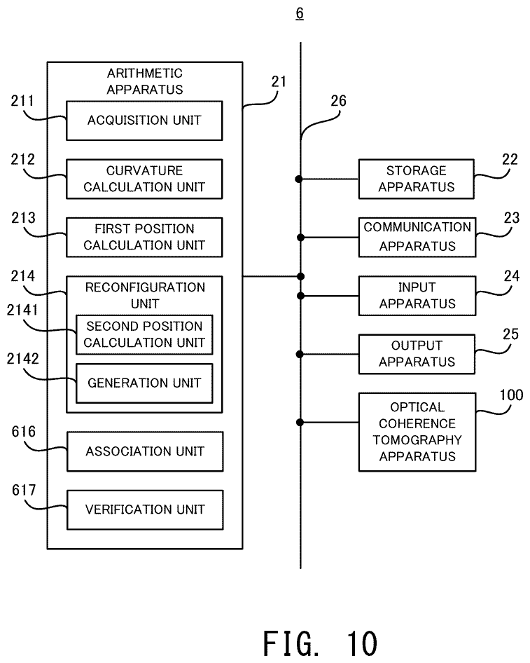

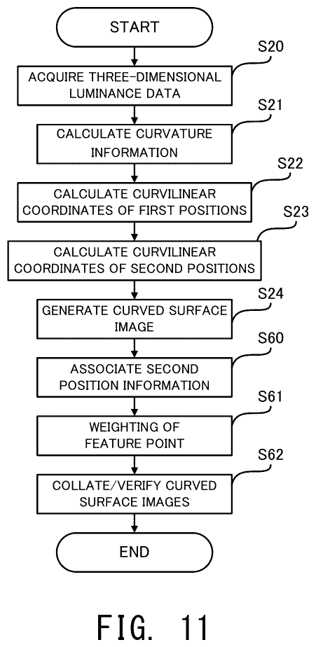

With reference to FIG. 9, a flow of an information processing operation performed by the information processing apparatus 5 in the fifth example embodiment will be described. FIG. 9 is a flowchart illustrating the flow of the information processing operation performed by the information processing apparatus 5 in the fifth example embodiment.

As illustrated in FIG. 9, the acquisition unit 211 acquires the three-dimensional luminance data generated by irradiating the target with the light beam while performing the two-dimensional scanning and by performing the optical coherence tomography (step S20). The three-dimensional luminance data include three-dimensional information on a predetermined number of first positions. The curvature calculation unit 212 calculates the curvature information indicating the curvature of the surface of the target, on the basis of the three-dimensional luminance data (step S21). The first position calculation unit 213 calculates the curvilinear coordinates of the predetermined number of first positions on the surface of the target, on the basis of the curvature information (step S22). The second position calculation unit 2141 calculates the curvilinear coordinates of the plurality of second positions on the surface of the target, which are different from the predetermined number of first positions, on the basis of the curvature information and the curvilinear coordinates of the predetermined number of first positions (step S23). The generation unit 2142 generates the curved surface image indicating the surface of the target, on the basis of the curvilinear coordinates of the predetermined number of first positions and the curvilinear coordinates of the plurality of second positions (step S24).

The learning unit 515 acquires original three-dimensional luminance data including three-dimensional information on a larger number of original positions than the predetermined number, calculates the curvature information indicating the curvature of the surface of the target based on the three-dimensional luminance data, and calculates the curvilinear coordinates of the original positions on the surface of the target based on the curvature information, thereby generating an original curved surface image indicating the surface of the target based on the curvilinear coordinates of the original positions (step S50).

The learning unit 515 compares the curved surface image generated in the step S24 with the original curved surface image generated in the step S50 (step S51). The learning unit 515 causes the reconfiguration unit 214 to learn a method of reconstructing the curved surface image such that the curved surface image generated on the basis of the three-dimensional data is similar to the original curved surface image indicating the surface of the target generated on the basis of the original three-dimensional data including the three-dimensional information on the larger number of original positions than the predetermined number (step S52).

That is, the reconfiguration unit 214 may learn the method of reconstructing the curved surface image such that the curved surface image generated on the basis of the three-dimensional luminance data including the three-dimensional information on the predetermined number of first positions is similar to the original curved surface image generated on the basis of the original three-dimensional luminance data including the three-dimensional information on the larger number of original positions than the predetermined number.

Furthermore, the learning unit 515 may build a curved surface image reconstruction model that allows the generation of the curved surface image that is similar to the original curved surface image. The curved surface image reconstruction model may be a model that outputs the curved surface image when the curvature information and the curvilinear coordinates of the plurality of first positions are inputted. The reconfiguration unit 214 may generate the curved surface image, by using the curved surface image reconstruction model. The reconfiguration unit 214 is capable of generating an accurate curved surface image that is similar to the original curved surface image, by using a learned curved surface image reconstruction model.

A parameter defining the operation of the curved surface image reconstruction model may be stored in the storage apparatus 22. The parameter defining the operation of the curved surface image reconstruction model may be updated by a learning operation, and may be a weight and bias of a neural network, for example.

### [5-3: Technical Effect of Information Processing Apparatus 5]

Since the information processing apparatus 5 in the fifth example embodiment causes the reconfiguration unit 214 to learn the method of reconstructing the curved surface image such that the curved surface image is similar to the original curved surface image generated on the basis of the original three-dimensional data including the three-dimensional information on the original positions, the reconfiguration unit 214 is capable of generating an accurate curved surface image of the target, on the basis of the three-dimensional data including the three-dimensional information on the predetermined number of first positions.

### 6: Sixth Example Embodiment

An information processing apparatus, an information processing method, and a recording medium according to a sixth example embodiment will be described. The following describes the information processing apparatus, the information processing method, and the recording medium according to the sixth example embodiment, by using an information processing apparatus 6 to which the information processing apparatus, the information processing method, and the recording medium according to the sixth example embodiment are applied.

[6-1: Configuration of Information processing Apparatus 6]

With reference to FIG. 10, a configuration of the information processing apparatus 6 in the sixth example embodiment will be described. FIG. 10 is a block diagram illustrating the configuration of the information processing apparatus 6 in the sixth example embodiment.

As illustrated in FIG. 10, the information processing apparatus 6 in the sixth example embodiment includes the arithmetic apparatus 21 and the storage apparatus 22, as in at least one of the information processing apparatus 2 in the second example embodiment to the information processing apparatus 5 in the fifth example embodiment. Furthermore, the information processing apparatus 6 may include the optical coherence tomography apparatus 100, the communication apparatus 23, the input apparatus 24, and the output apparatus 25, as in at least one of the information processing apparatus 2 in the second example embodiment to the information processing apparatus 5 in the fifth example embodiment. The information processing apparatus 6, however, may not include at least one of the optical coherence tomography apparatus 100, the communication apparatus 23, the input apparatus 24, and the output apparatus 25. The information processing apparatus 6 in the sixth example embodiment is different from at least one of the information processing apparatus 2 in the second example embodiment to the information processing apparatus 5 in the fifth example embodiment, in that the arithmetic apparatus 21 includes an association unit 616 and a verification unit 617. Other features of the information processing apparatus 6 may be the same as those of at least one of the information processing apparatus 2 in the second example embodiment to the information processing apparatus in the fifth example embodiment. For this reason, a part that is different from each of the example embodiments described above will be described in detail below, and a description of the other overlapping parts will be omitted as appropriate.

### [6-2: Information Processing Operation by Information Processing Apparatus 6]

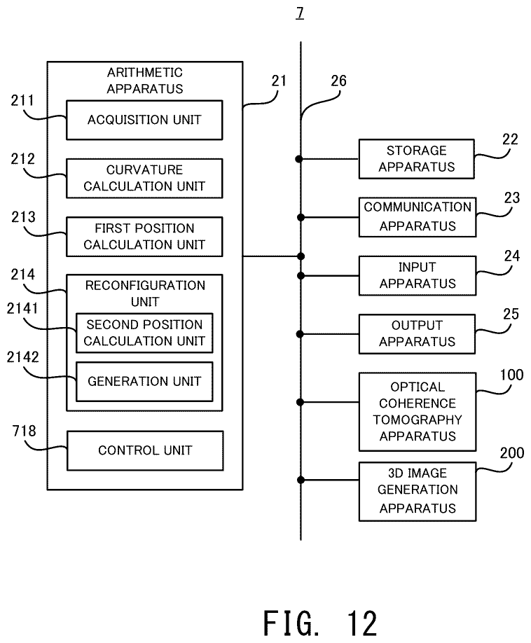

With reference to FIG. 11, a flow of an information processing operation performed by the information processing apparatus 6 in the sixth example embodiment will be described. FIG. 11 is a flowchart illustrating the flow of the information operation performed by the information processing apparatus 6 in the sixth example embodiment.

As illustrated in FIG. 11, the acquisition unit 211 acquires the three-dimensional luminance data generated by irradiating the target with the light beam while performing the two-dimensional scanning and by performing the optical coherence tomography (step S20). The curvature calculation unit 212 calculates the curvature information indicating the curvature of the surface of the target, on the basis of the three-dimensional luminance data (step S21). The first position calculation unit 213 calculates the curvilinear coordinates of the plurality of first positions on the surface of the target, on the basis of the curvature information (step S22). The second position calculation unit 2141 calculates the curvilinear coordinates of the plurality of second positions on the surface of the target, which are different from the plurality of first positions, on the basis of the curvature information and the curvilinear coordinates of the plurality of first positions (step S23). The generation unit 2142 generates the curved surface image indicating the surface of the target, on the basis of the curvilinear coordinates of the plurality of first positions and the curvilinear coordinates of the plurality of second positions (step S24).

The association unit 616 extracts a feature point included in the curved surface image. For example, when the curved surface image is a pattern image illustrating a pattern of a skin, the feature point of the pattern image may include an “edge point” that is a point at which the pattern is interrupted, and a “branch point” that is a point at which the pattern is branched. When the feature point included in the curved surface image is in an area based on the second position, the association unit 616 associates second position information indicating that the feature point is based on the second position, with the corresponding feature point (step S60).

The feature point of the pattern image may be a position where a feature of the pattern image may be captured well. For example, when the pattern images are collated/verified with each other, the feature point may be a position used to compare the two. Therefore, in many cases, a more reliable location is preferably adopted as the position where the feature of the pattern image may be captured well. In many cases, it is preferably possible to distinguish, from which area the position extracted position as the feature point is derived, i.e., whether it is derived from an area other than the area based on the second position, or from the area based on the second position. The information processing apparatus 6 in the sixth example embodiment is capable of distinguishing whether it is derived from an area other than the area based on the second position, or from the area based on the second position.

The verification unit 617 reduces weighting of the feature point with which the second position information is associated (step S61).

The verification unit 617 collates/verifies the curved surface image with the registration curved surface image registered in advance (step S62).

### [6-3: Technical Effect of Information Processing Apparatus 6]

Since the information processing apparatus 6 in the sixth example embodiment associates the second position information indicating that the feature point is based on the second position, with the feature point, it is possible to determine whether or not the corresponding position is used in processing as the feature point, in accordance with the application. In particular, information that allows the determination of whether or not the position can be used for the collation/verification, is useful in the collation/verification of the pattern images.

### 7: Seventh Example Embodiment

An information processing apparatus, an information processing method, and a recording medium according to a seventh example embodiment will be described. The following describes the information processing apparatus, the information processing method, and the recording medium according to the seventh example embodiment, by using an information processing apparatus 7 to which the information processing apparatus, the information processing method, and the recording medium according to the seventh example embodiment are applied.

[7-1: Configuration of Information processing Apparatus 7]

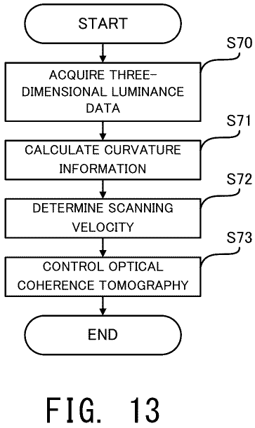

With reference to FIG. 12, a configuration of the information processing apparatus 7 in the seventh example embodiment will be described. FIG. 12 is a block diagram illustrating the configuration of the information processing apparatus 7 in the seventh example embodiment.

As illustrated in FIG. 12, the information processing apparatus 7 in the seventh example embodiment includes the arithmetic apparatus 21 and the storage apparatus 22, as in at least one of the information processing apparatus 2 in the second example embodiment to the information processing apparatus 6 in the sixth example embodiment. Furthermore, the information processing apparatus 7 may include the optical coherence tomography apparatus 100, the communication apparatus 23, the input apparatus 24, and the output apparatus 25, as in at least one of the information processing apparatus 2 in the second example embodiment to the information processing apparatus 6 in the sixth example embodiment. The information processing apparatus 7, however, may not include at least one of the optical coherence tomography apparatus 100, the communication apparatus 23, the input apparatus 24, and the output apparatus 25. The information processing apparatus 7 in the seventh example embodiment is different from at least one of the information processing apparatus 2 in the second example embodiment to the information processing apparatus 6 in the sixth example embodiment, in that the arithmetic apparatus 21 includes a control unit 718. Other features of the information processing apparatus 7 may be the same as those of at least one of the information processing apparatus 2 in the second example embodiment to the information processing apparatus 6 in the sixth example embodiment. For this reason, a part that is different from each of the example embodiments described above will be described in detail below, and a description of the other overlapping parts will be omitted as appropriate.

### [7-2: Control Operation of Optical Coherence Tomography Apparatus 100 by Information Processing Apparatus 7]

With reference to FIG. 13, a flow of a control operation of the optical coherence tomography apparatus 100 performed by the information processing apparatus 7 in the seventh example embodiment will be described. FIG. 13 is a flowchart illustrating the flow of the control operation of the optical coherence tomography apparatus 100 performed by the information processing apparatus 7 in the seventh example embodiment.

As illustrated in FIG. 13, the acquisition unit 211 acquires the three-dimensional luminance data generated by irradiating the target with the light beam while performing the two-dimensional scanning and by performing the optical coherence tomography (step S70). In the optical coherence tomography for generating the three-dimensional luminance data to be acquired in the step S70, the number of the irradiation positions of a plurality of rays of object light by the optical coherence tomography apparatus 100 may be less than the number of the plurality of first positions. For example, the number of the irradiation positions of the plurality of rays of object light may be less than half the number of the plurality of first positions.

The curvature calculation unit 212 calculates the curvature information indicating the curvature of the surface of the target, on the basis of the three-dimensional luminance data acquired in the step S70 (step S71).

The control unit 718 determines a scanning velocity at which the scanner unit of the optical coherence tomography apparatus 100 relatively moves the irradiation position of the light, on the basis of the curvature information calculated in step S71 (step S72). The control unit 718 may divide an area corresponding to an area where the optical coherence tomography is performed, into a predetermined number of minute areas, and may calculate the curvature information on each minute area, for example. In this instance, the control unit 718 may determine the scanning velocity at which the scanner unit of the optical coherence tomography apparatus 100 relatively moves the irradiation position of the light, in each minute area.

The control unit 718 controls the scanning by the light in each minute area, by relatively moving the irradiation position at the velocity determined in the step S72, with respect to each minute area (step S73). The control unit 718 may control optical coherence tomography scanning by the scanner unit of the optical coherence tomography apparatus 100.

In the step S20 in each of the above example embodiments, the three-dimensional luminance data generated by performing the optical coherence tomography in step S73, may be acquired.

For example, when the target is a finger, in many cases, the curvature increases as it is further away from a central part of an imaging area. Since the resolution tends to decrease in an area having a large curvature, it is preferable to obtain more detailed information. When the target is scanned at a low velocity, information on the target may be obtained in narrower intervals than those when the target is scanned at a high velocity. Therefore, the control unit 718 may perform the relative movement on an area away from the central part of the imaging area, at a lower velocity than that in an area of the central part of the imaging area. As a result, the three-dimensional data are generated such that as it is further away from a central part of an area in which there are the plurality of first positions, density of the plurality of first positions is higher.

The information processing apparatus 7 in the seventh example embodiment may include a three-dimensional image generation apparatus, or may transmit information to and receive information from the three-dimensional image generation apparatus through the communication apparatus 23. The three-dimensional image generation apparatus may generate a three-dimensional image of the target, and may generate a three-dimensional image of the target including at least an area in which the three-dimensional luminance data are acquired. In this instance, the control unit 718 measures the curvature of each minute area on the basis of the three-dimensional image, and the control unit 718 may determine the scanning velocity at which the scanner unit of the optical coherence tomography apparatus 100 relatively moves the irradiation position of the light, on the basis of the curvature of each minute area.

### [7-3: Technical Effect of Information Processing Apparatus 7]

The information processing apparatus 7 in the seventh example embodiment is capable of obtaining the information on the target in narrower intervals, in an area having a larger curvature.

In each of the example embodiments described above, described is an example in which the target is a hand, but the target is not limited to the hand. Each of the example embodiments described above is applicable to a target other than the hand. For example, the target may be a skin of a body other than the hand, an iris, a fruit, or the like. The skin of the body other than the hand may be, for example, a skin of a foot. When the optical coherence tomography is performed on the skin of the hand and the foot, light transmitted through resins or the like may be used. Since the iris includes muscle fibers, feature quantities of the iris may be obtained from an optical coherence tomography image. Each of the example embodiments described above may be used in a situation where it is preferable to measure a state on a surface or near the surface of the skin of the body, the iris, the fruit, or the like, in a noninvasive manner.

### 8: Supplementary Notes

With respect to the example embodiment described above, the following Supplementary Notes are further disclosed.
[Supplementary Note 1]

An information processing apparatus including:
an acquisition unit that acquires three-dimensional data on a target;
a curvature calculation unit that calculates curvature information indicating a curvature of a surface of the target, on the basis of the three-dimensional data;
a first position calculation unit that calculates curvilinear coordinates of a plurality of first positions on the surface of the target, on the basis of the curvature information; and
a reconfiguration unit including: a second position calculation unit that calculates curvilinear coordinates of a plurality of second positions on the surface of the target, which are different from the plurality of first positions, on the basis of the curvature information and the curvilinear coordinates of the plurality of first positions; and a generation unit that generates a curved surface image indicating the surface of the target, on the basis of the curvilinear coordinates of the plurality of first positions and the curvilinear coordinates of the plurality of second positions.
[Supplementary Note 2]

The information processing apparatus according to Supplementary Note 1, wherein the three-dimensional data are three-dimensional luminance data generated by performing the optical coherence tomography by irradiating the target with a light beam while performing two-dimensional scanning and by performing optical coherence tomography.
[Supplementary Note 3]

The information processing apparatus according to Supplementary Note 1 or 2, wherein the second position calculation unit calculates the curvilinear coordinates of a larger number of second positions in an area having a larger curvature of the surface of the target, on the basis of the curvature information and the curvilinear coordinates of the plurality of first positions.
[Supplementary Note 4]

The information processing apparatus according to Supplementary Note 1 or 2, wherein the reconfiguration unit generates the curved surface image by applying compressive sensing.
[Supplementary Note 5]

The information processing apparatus according to Supplementary Note 1 or 2, wherein
the three-dimensional data include three-dimensional information on a predetermined number of first positions, and
the information processing apparatus further includes a learning unit that causes the reconfiguration unit to learn a method of reconstructing the curved surface image such that the curved surface image generated on the basis of the three-dimensional data is similar to an original curved surface image indicating a surface of the target generated on the basis of original three-dimensional data including the three-dimensional information on a larger number of original positions than the predetermined number.
[Supplementary Note 6]

The information processing apparatus according to Supplementary Note 1 or 2, further including:
an association unit that, when a feature point included in the curved surface image is in an area based on the second position, associates second position information indicating that the feature point is based on the second position, with the corresponding feature point; and
a verification unit that collates/verifies the curved surface image with a registration curved surface image registered in advance, wherein
the verification unit reduces weighting of the feature point with which the second positional data is associated.
[Supplementary Note 7]

The information processing apparatus according to Supplementary Note 1 or 2, wherein the three-dimensional data are generated such that as it is further away from a central part of an area in which there are the plurality of first positions, density of the plurality of first positions is higher.
[Supplementary Note 8]

An information processing method including:
acquiring three-dimensional data on a target;
calculating curvature information indicating a curvature of a surface of the target, on the basis of the three-dimensional data;
calculating curvilinear coordinates of a plurality of first positions on the surface of the target, on the basis of the curvature information;
calculating curvilinear coordinates of a plurality of second positions on the surface of the target, which are different from the plurality of first positions, on the basis of the curvature information and the curvilinear coordinates of the plurality of first positions; and
generating a curved surface image indicating the surface of the target, on the basis of the curvilinear coordinates of the plurality of first positions and the curvilinear coordinates of the plurality of second positions.
[Supplementary Note 9]

A recording medium on which a computer program that allows a computer to execute an information processing method is recorded, the information processing method including:
acquiring three-dimensional data on a target;
calculating curvature information indicating a curvature of a surface of the target, on the basis of the three-dimensional data;
calculating curvilinear coordinates of a plurality of first positions on the surface of the target, on the basis of the curvature information;
calculating curvilinear coordinates of a plurality of second positions on the surface of the target, which are different from the plurality of first positions, on the basis of the curvature information and the curvilinear coordinates of the plurality of first positions; and
generating a curved surface image indicating the surface of the target, on the basis of the curvilinear coordinates of the plurality of first positions and the curvilinear coordinates of the plurality of second positions.

At least a part of the constituent components of each of the example embodiments described above can be combined with at least another part of the constituent components of each of the example embodiments described above, as appropriate. A part of the constituent components of each of the example embodiments described above may not be used.

This disclosure is not limited to the examples described above. This disclosure is allowed to be changed, if desired, without departing from the essence or spirit of this disclosure which can be read from the claims and the entire identification. An information processing apparatus, an information processing method, and a recording medium with such changes are also intended to be within the technical scope of this disclosure. Furthermore, to the extent permitted by law, all publications and papers described herein are incorporated herein by reference.

To the extent permitted by law, this application claims the benefit of priority based on Japanese Patent application No. 2022-096468, filed Jun. 15, 2022, the entire disclosure of which is incorporated herein in its entirety by reference.

### DESCRIPTION OF REFERENCE CODES

1, 2, 3, 4, 5, 6, 7 Information processing apparatus
100 Optical coherence tomography apparatus
11, 211 Acquisition unit
12, 212 Curvature calculation unit
13, 213 First position calculation unit
14, 214 Reconfiguration unit
141, 2141 Second position calculation unit
142, 2142 Generation unit
515 Learning unit
616 Association unit
617 Verification unit
718 Control unit

What is claimed is:

1. An information processing apparatus comprising:
at least one memory that is configured to store instructions; and
at least one processor that is configured to execute the instructions to:
acquire three-dimensional data on a target;
calculate curvature information indicating a curvature of a surface of the target, on the basis of the three-dimensional data;
calculate curvilinear coordinates of a plurality of first positions on the surface of the target, on the basis of the curvature information;
calculate curvilinear coordinates of a plurality of second positions on the surface of the target, which are different from the plurality of first positions, on the basis of the curvature information and the curvilinear coordinates of the plurality of first positions; and
generate a curved surface image indicating the surface of the target, on the basis of the curvilinear coordinates of the plurality of first positions and the curvilinear coordinates of the plurality of second positions.

2. The information processing apparatus according to claim 1, wherein the three-dimensional data are three-dimensional luminance data generated by performing the optical coherence tomography by irradiating the target with a light beam while performing two-dimensional scanning and by performing optical coherence tomography.

3. The information processing apparatus according to claim 1, wherein the at least one processor is configured to execute the instructions to calculate the curvilinear coordinates of a larger number of second positions in an area having a larger curvature of the surface of the target, on the basis of the curvature information and the curvilinear coordinates of the plurality of first positions.

4. The information processing apparatus according to claim 1, wherein the at least one processor is configured to execute the instructions to generate the curved surface image by applying compressive sensing.

5. The information processing apparatus according to claim 1, wherein
the three-dimensional data include three-dimensional information on a predetermined number of first positions, and
the at least one processor is configured to execute the instructions to learn a method of reconstructing the curved surface image such that the curved surface image generated on the basis of the three-dimensional data is similar to an original curved surface image indicating a surface of the target generated on the basis of original three-dimensional data including the three-dimensional information on a larger number of original positions than the predetermined number.

6. The information processing apparatus according to claim 1, wherein the at least one processor is configured to execute the instructions to:
when a feature point included in the curved surface image is in an area based on the second position, associate second position information indicating that the feature point is based on the second position, with the corresponding feature point;
collate/verify the curved surface image with a registration curved surface image registered in advance; and
the at least one processor is configured to execute the instructions to reduce weighting of the feature point with which the second positional data is associated.

7. The information processing apparatus according to claim 1, wherein the three-dimensional data are generated such that as it is further away from a central part of an area in which there are the plurality of first positions, density of the plurality of first positions is higher.

8. An information processing method comprising:
acquiring three-dimensional data on a target;
calculating curvature information indicating a curvature of a surface of the target, on the basis of the three-dimensional data;
calculating curvilinear coordinates of a plurality of first positions on the surface of the target, on the basis of the curvature information;
calculating curvilinear coordinates of a plurality of second positions on the surface of the target, which are different from the plurality of first positions, on the basis of the curvature information and the curvilinear coordinates of the plurality of first positions; and
generating a curved surface image indicating the surface of the target, on the basis of the curvilinear coordinates of the plurality of first positions and the curvilinear coordinates of the plurality of second positions.

9. A non-transitory recording medium on which a computer program that allows a computer to execute an information processing method is recorded, the information processing method including:
acquiring three-dimensional data on a target;
calculating curvature information indicating a curvature of a surface of the target, on the basis of the three-dimensional data;
calculating curvilinear coordinates of a plurality of first positions on the surface of the target, on the basis of the curvature information;
calculating curvilinear coordinates of a plurality of second positions on the surface of the target, which are different from the plurality of first positions, on the basis of the curvature information and the curvilinear coordinates of the plurality of first positions; and
generating a curved surface image indicating the surface of the target, on the basis of the curvilinear coordinates of the plurality of first positions and the curvilinear coordinates of the plurality of second positions.
